(19) United States
(12) Patent Application Publication
(10) Pub. No.: US 2026/0249627 A1
(43) Pub. Date: Aug. 27, 2026

(54) SHEET FEEDING DEVICE

(71) Applicant: BROTHER KOGYO KABUSHIKI KAISHA, Nagoya (JP)

(72) Inventor: Kimio TAKEUCHI, Konan (JP)

(73) Assignee: BROTHER KOGYO KABUSHIKI KAISHA, Nagoya (JP)

(21) Appl. No.: 19/546,562

(22) Filed: Feb. 23, 2026

(30) Foreign Application Priority Data
Feb. 25, 2025 (JP) 2025-028125

(51) Int. Cl. B41J 13/14; B41J 13/02; B41J 13/10

(52) U.S. Cl. CPC B41J 13/14; B41J 13/02; B41J 13/103

(57) ABSTRACT

A sheet feeding device includes a supply tray with a support surface supporting stacked sheets, and a feeding roller that feeds an uppermost sheet in a feeding direction orthogonal to a widthwise direction of the sheets. A first guide surface downstream of the support surface guides the fed sheet. A second guide surface downstream and alongside the first guide surface in the widthwise direction guides a sheet portion to lift it away from the first guide surface. A friction member includes a first portion on the support surface facing the feeding roller from below to apply friction to stacked sheets, and a second portion on the first guide surface alongside the second guide surface, with a downstream region positioned below the second guide surface to apply friction to guided sheets. This configuration suppresses double feeding even when sheets are deformed.

### REFERENCE TO RELATED APPLICATIONS

This application claims priority from Japanese Patent Application No. 2025-028125 filed on February 25, 2025. The entire content of the priority application is incorporated herein by reference.

### BACKGROUND ART

The present disclosure relates to a sheet feeding device.

Conventionally, a document conveying device has been known as one example of a sheet feeding device. Such a conventional device typically includes a document placing section (i.e., a platen), a pickup roller, and a friction member.

The document placing section supports sheets in a stacked state. The pickup roller is configured to feed the sheets supported on the document placing section in a feeding direction that is orthogonal to a widthwise direction of the sheets placed on the document placing section.

The friction member may be formed of a cork sheet or the like. The friction member is provided on the document placing section so as to face the pickup roller from below. By applying friction to the sheets supported on the document placing section, the friction member suppresses the occurrence of double feeding during sheet conveyance.

### SUMMARY

In the conventional document conveying device as described above, sheets that have been deformed, for example by acquiring a curl or warping due to humidity, may be supported in a stacked state on the document placing section. When the pickup roller attempts to feed such deformed sheets one by one, the contact pressure of the pickup roller on the sheets tends to fluctuate, and the frictional force that the friction member applies to the sheets supported on the document placing section also tends to fluctuate. As a result, the sheets remaining on the document placing section tend to bounce and advance in the feeding direction. Consequently, it may become difficult for this document conveying device to reliably prevent double feeding of the sheets.

The present disclosure has been made in view of the above circumstances, and in some aspects, the present disclosure provides a sheet feeding device capable of suppressing double feeding of sheets even when deformed sheets are supported in a stacked state on a support surface.

According to aspects of the present disclosure, a sheet feeding device includes a supply tray having a support surface configured to support sheets in a stacked state, and a feeding roller configured to feed a sheet supported on the support surface in a feeding direction orthogonal to a widthwise direction of the sheets. A first guide surface is located downstream of the support surface in the feeding direction and guides the sheet fed by the feeding roller. A second guide surface is also located downstream of the support surface, arranged alongside the first guide surface in the widthwise direction, and guides a portion of the sheet in the widthwise direction to lift the portion away from the first guide surface. The sheet feeding device further includes a friction member having a first portion and a second portion. The first portion is provided on the support surface, faces the feeding roller from below, and applies a frictional force to a sheet supported on the support surface. The second portion is provided on the first guide surface, arranged alongside the second guide surface in the widthwise direction, and has at least a part including a downstream end in the feeding direction located below the second guide surface. The second portion is capable of applying a frictional force to a sheet guided by the first guide surface and the second guide surface.

In the sheet feeding device described above, deformed sheets, for example sheets that have acquired a curl set or have curled due to humidity, may be supported in a stacked state on the support surface of the supply tray. When the feeding roller attempts to feed such deformed sheets one by one, a pressing force applied by the feeding roller to the sheets tends to fluctuate, and a frictional force applied by the first portion of the friction member to the sheets supported on the support surface also tends to fluctuate. If no countermeasure is taken, the sheets remaining on the support surface tend to bounce and advance in the feeding direction.

In this regard, the sheet feeding device described above includes a first guide surface and a second guide surface. The friction member includes a first portion and a second portion.

When deformed sheets are supported in a stacked state on the support surface, sheets remaining on the support surface may bounce and tend to move toward the first guide surface and the second guide surface. In such a case, the deformed sheets are more likely to come into contact with the second portion of the friction member, particularly with a part of the second portion including a downstream end in the feeding direction. As a result, the second portion applies a frictional force to the deformed sheets and suppresses the deformed sheets from advancing in the feeding direction.

When non-deformed sheets are supported in a stacked state on the support surface, feeding by the feeding roller does not cause large fluctuations in a pressing force applied to the sheets, and a frictional force applied by the first portion of the friction member to the sheets supported on the support surface also does not fluctuate significantly. Accordingly, sheets remaining on the support surface are unlikely to bounce or advance in the feeding direction. When a non-deformed sheet is guided by the first guide surface and the second guide surface, the non-deformed sheet tends to lift away from the second portion, particularly from a part of the second portion including a downstream end in the feeding direction. As a result, the second portion is less likely to apply a frictional force to the non-deformed sheet, thereby suppressing an unintended situation in which the non-deformed sheet is unnecessarily stopped by the second portion.

Therefore, even when deformed sheets are supported in a stacked state on the support surface, the sheet feeding device described above can suppress double feeding of the sheets.

### BRIEF DESCRIPTION OF THE DRAWINGS

FIG. 1 is a perspective view of an image reading apparatus according to a present embodiment.

FIG. 2 is a schematic partial cross-sectional view of the image reading apparatus according to the present embodiment.

FIG. 3 is a partial perspective view of the image reading apparatus according to the present embodiment, illustrating a state in which a left-end upper cover, a holder, a feeding roller, a separation roller, and the like are removed.

FIG. 4 is an enlarged partial perspective view of a principal part shown in FIG. 3.

FIG. 5 is a partial plan view showing a support surface, a first guide surface, a second guide surface, a friction member, and the like.

FIG. 6 is an enlarged schematic partial cross-sectional view of a principal part shown in FIG. 2.

FIG. 7 is an enlarged schematic partial cross-sectional view of a principal part shown in FIG. 6.

FIG. 8 is a schematic partial cross-sectional view taken along line A-A in FIG. 7, illustrating a state in which non-deformed sheets are about to be double-fed.

FIG. 9 is a schematic partial cross-sectional view similar to FIG. 8, illustrating a state in which deformed sheets are about to be double-fed.

### DESCRIPTION

Hereinafter, an embodiment in which the present disclosure is implemented will be described with reference to the accompanying drawings.

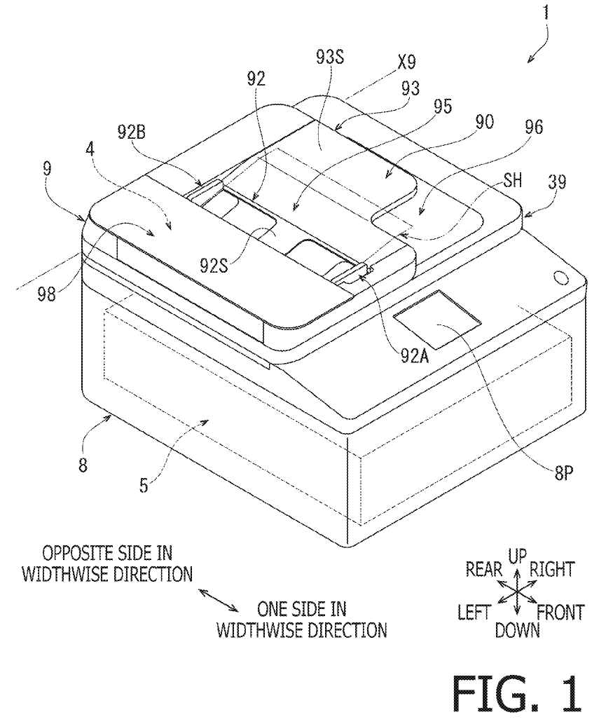

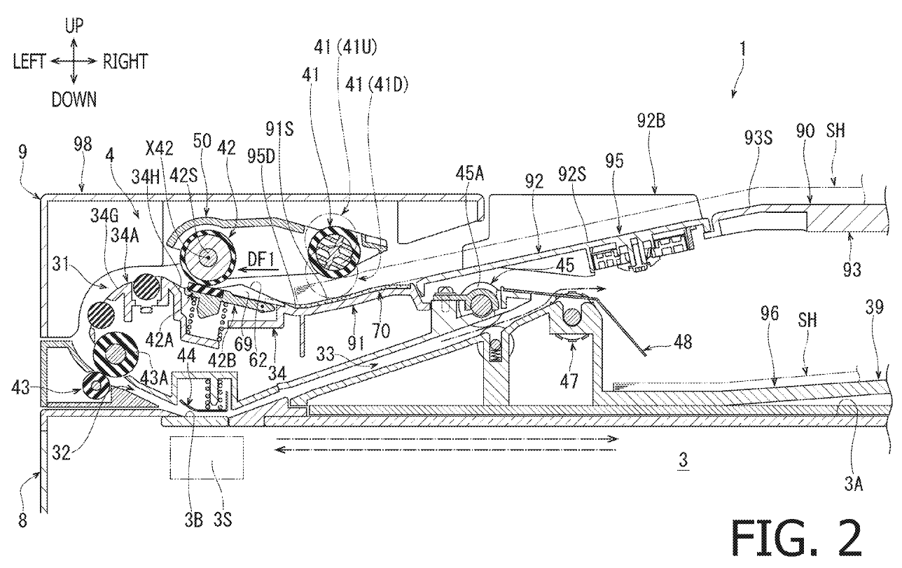

FIG. 1 shows an image reading apparatus 1, which is an example of a sheet feeding device according to an embodiment of the present disclosure. In FIG. 1, a side of the image reading apparatus 1 on which an operation panel 8P is provided is defined as a front side of the image reading apparatus 1, and a side that comes to the left when a user faces the operation panel 8P is defined as a left side of the image reading apparatus 1. In FIG. 2 and the subsequent figures, a front-rear direction, a left-right direction, and an up-down direction are indicated so as to correspond to the respective directions defined in FIG. 1.

As shown in FIG. 1, the image reading apparatus 1 includes a main body 8 and a cover 9. The main body 8 has a generally flat, box-shaped configuration. The operation panel 8P, such as a touch panel, is located on the front surface of the main body 8. A lower portion of the main body 8 accommodates an image forming unit 5. The image forming unit 5 is a hardware component configured to form an image on a sheet by an inkjet method, a laser method, or another suitable printing method.

As shown in FIG. 2, an upper portion of the main body 8 accommodates an image reading unit 3. The image reading unit 3 is hardware including a document supporting surface 3A (hereinafter, also referred to as a "supporting surface"), a reading surface 3B, a reading sensor 3S, and a well-known scanning mechanism.

The supporting surface 3A is an upper surface of a large-area glass plate located on an upper surface of the main body 8. The reading surface 3B is an upper surface of a glass plate that is located to the left of the supporting surface 3A on the upper surface of the main body 8 and extends in a slender shape in a front-rear direction.

The supporting surface 3A is configured to support a document that is a target of image reading. The document may be a sheet such as paper or an OHP sheet or may be a book or the like. The reading surface 3B is used when reading a sheet conveyed by a conveying unit 4, as described later. It should be noted that the conveying unit 4 is a hardware component.

The reading sensor 3S is a well-known image reading sensor such as a contact image sensor (CIS) or a charge coupled device (CCD) and has an elongated shape extending in the front-rear direction. The reading sensor 3S is configured to be located below both the supporting surface 3A and the reading surface 3B. Specifically, the reading sensor 3S is movably positioned below the supporting surface 3A when a document placed on the supporting surface 3A is read, whereas the reading sensor 3S is held stationary below the reading surface 3B when a sheet conveyed by the conveying unit 4 and passing over the reading surface 3B is read.

When the image reading unit 3 reads an image of a document supported on the supporting surface 3A, the reading sensor 3S moves in a sub-scanning direction by operation of a scanning mechanism (not shown). More specifically, the reading sensor 3S moves from a position below a left-side edge of the supporting surface 3A toward a position below a right-side edge of the supporting surface 3A while linearly reading the document in a main scanning direction. After reaching the position below the right-side edge, the reading sensor 3S finishes reading and returns to a standby position by operation of the scanning mechanism.

When the conveying unit 4, which will be described later, operates, the reading sensor 3S is first moved by the scanning mechanism to a fixed reading position below the reading surface 3B, and remains stationary at that position to read a sheet conveyed by the conveying unit 4.

As shown in FIG. 1, a cover 9 is located above the main body 8. A rear end of the cover 9 is connected to a rear end of the main body 8 via a hinge (not shown), allowing the cover 9 to swing about a swing axis X9 extending in a left-right direction.

As shown in FIG. 2, the cover 9 includes a base member 39. A lower surface of the base member 39 forms a bottom surface of the cover 9. The bottom surface of the cover 9 has a size large enough to cover the supporting surface 3A and the reading surface 3B. The bottom surface of the cover 9 is also large enough to cover a document placed on the supporting surface 3A.

The base member 39 is an integrally molded product made of a resin material. In the present embodiment, the base member 39 is manufactured by injection molding of a thermoplastic resin or by another suitable thermoplastic resin molding method.

When the user swings the cover 9 upward and rearward (that is, counterclockwise as viewed in FIG. 2) about the swing axis X9, the supporting surface 3A is uncovered. In this state, the user can place a document on the supporting surface 3A or remove the document from the supporting surface 3A.

As shown in FIGS. 1 and 2, the cover 9 includes a supply tray 90 and a discharge tray 96. The supply tray 90 and the discharge tray 96 are located in a right-side portion of the cover 9.

As shown in FIG. 2, an upper surface of a right-side portion of the base member 39 forms the discharge tray 96. The discharge tray 96 is configured to support sheets SH whose images have been read and which are discharged.

As shown in FIG. 2, the supply tray 90 is located above the discharge tray 96. The supply tray 90 has a support surface 95 configured to support sheets SH, whose images are to be read, in a stacked state.

In the present embodiment, an object whose image is to be read while being placed on the supporting surface 3A is referred to as a "document," and an object that is supported on the support surface 95 and whose image is read while being conveyed by the conveying unit 4 is referred to as a "sheet SH." A document and a sheet SH may be substantially the same in nature so long as the document is in the form of a sheet.

The support surface 95 extends in a front-rear direction while gently sloping downward toward the left. A widthwise direction of the support surface 95 is the front-rear direction. In the present embodiment, one side and its opposite side in the widthwise direction correspond to a front side and a rear side, respectively.

A feeding direction DF1 in which the sheets SH supported on the support surface 95 are fed is a direction in which the sheets SH move leftward and is orthogonal to the widthwise direction.

A downstream end 95D of the support surface 95 in the feeding direction DF1 is located between a left side surface of the cover 9 and a central portion of the cover 9 in the left-right direction.

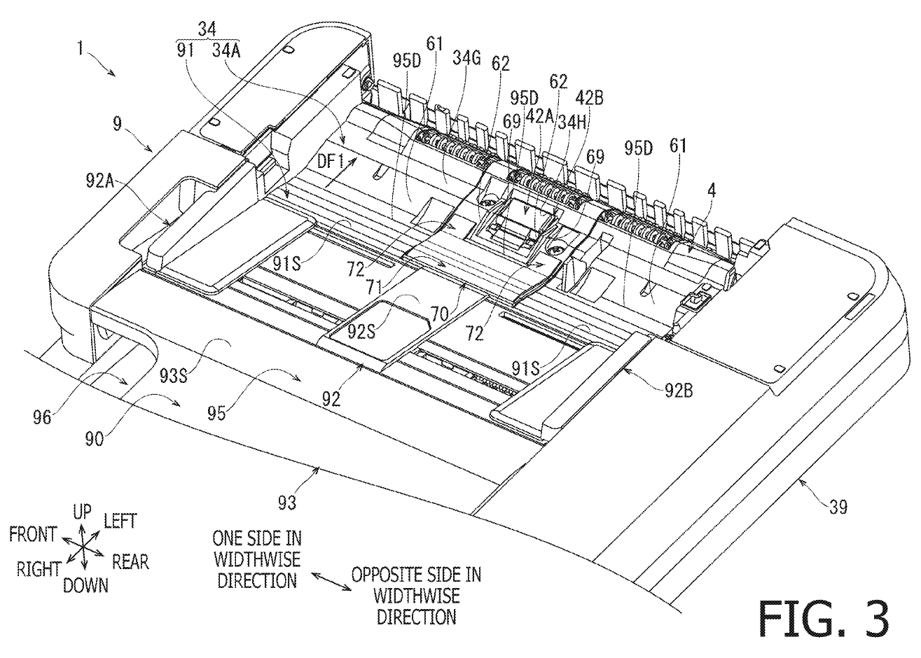

As shown in FIGS. 2 and 3, the cover 9 includes an upper chute 34. The upper chute 34 is located at a higher level than a left-side portion of the base member 39 and at a lower level than a left-side upper cover 98 and extends in a left-right direction and in a front-rear direction. A front-end portion and a rear end portion of the upper chute 34 are assembled to a front-end portion and a rear end portion of the left-side portion of the base member 39.

The upper chute 34 integrally includes a first tray 91 on a right side thereof and a guide portion 34A on a left side thereof. The first tray 91 extends from a right end of the upper chute 34 while gently sloping downward toward the left. The guide portion 34A extends while gently sloping upward toward the left and then curves downward. An upper surface of the guide portion 34A defines a conveyance guide surface 34G.

The upper chute 34 is an integrally molded product made of a resin material. In the present embodiment, the upper chute 34 is manufactured by injection molding of a thermoplastic resin or by another suitable thermoplastic resin molding method.

The supply tray 90 includes the first tray 91 described above, and further includes a second tray 92 and a sub tray 93, which are shown in FIGS. 1 to 3.

The first tray 91 has an upper surface that defines a first support surface 91S. The first support surface 91S constitutes a part of the support surface 95 and includes the downstream end 95D of the support surface 95.

A first portion 71 of a friction member 70, which will be described later, is attached to a central portion in the widthwise direction of the first support surface 91S.

As shown in FIGS. 2 and 3, a second tray 92 is located on the right side with respect to the first tray 91. The second tray 92 extends so as to gently slope downward toward the left and extends in the widthwise direction. Front and rear end portions of the second tray 92 are assembled to front and rear end portions of a left-side portion of the base member 39 at positions to the right of the first tray 91. An upper surface of the second tray 92 defines a second support surface 92S. The second support surface 92S is adjacent to the first support surface 91S from an upstream side in the feeding direction DF1.

A sub tray 93 is located on the right side with respect to the second tray 92 and is connected to front and rear end portions (not shown) of the second tray 92. The sub tray 93 has an upper surface that defines a third support surface 93S. The third support surface 93S is adjacent to the second support surface 92S from an upstream side in the feeding direction DF1.

The second support surface 92S and the third support surface 93S constitute remaining portions of the support surface 95 other than the first support surface 91S.

As shown in FIGS. 1 and 3, the supply tray 90 includes side guides 92A and 92B. The side guides 92A and 92B are disposed on the second support surface 92S of the second tray 92 and are slidable in the front-rear direction. By sliding toward and away from each other, the side guides 92A and 92B position sheets SH of various sizes, which are supported on the support surface 95, in the front-rear (widthwise) direction. In the present embodiment, examples of the sheets SH serving as targets of image reading include sheets having sizes from A5 to A4 and postcards.

As shown in FIGS. 3 to 5, the upper chute 34 includes a first guide surface 61, two ribs 69, and two second guide surfaces 62. The first guide surface 61, the ribs 69, and the second guide surfaces 62 are located downstream of the support surface 95 in the feeding direction DF1. The first guide surface 61 and the second guide surfaces 62 constitute part of the conveyance guide surface 34G.

As shown in FIG. 3, an upstream end in the feeding direction DF1 of the first guide surface 61 is connected to the downstream end 95D of the support surface 95. A length of the first guide surface 61 in the widthwise direction is the same as a length of the support surface 95 in the widthwise direction. The first guide surface 61 is inclined so as to rise toward a downstream side in the feeding direction DF1.

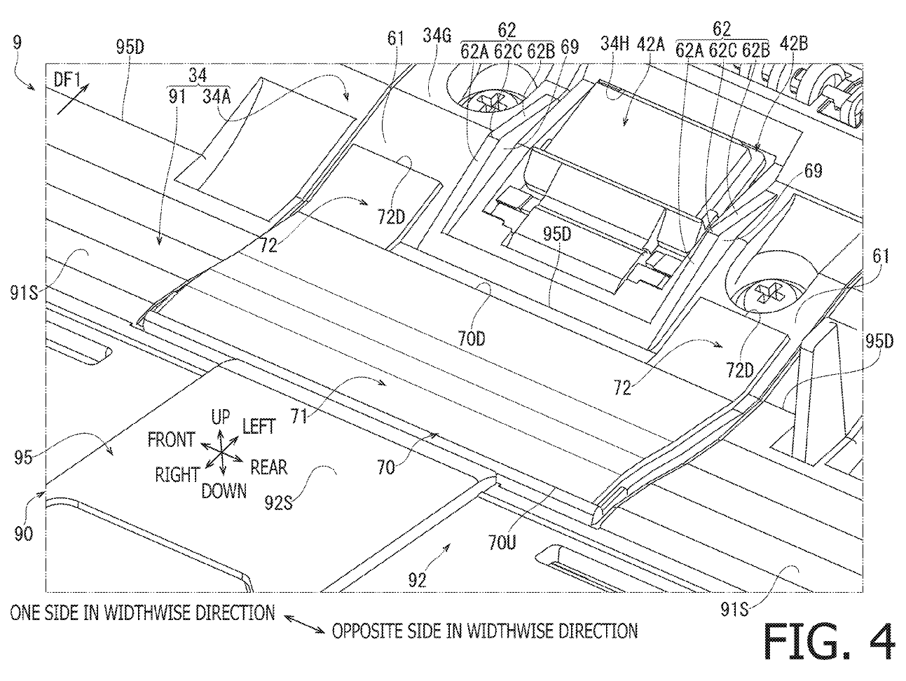

As shown in FIG. 4, an opening 34H having a substantially rectangular shape is formed in the upper chute 34. The opening 34H is located at a central portion in the widthwise direction of the first guide surface 61. A separation holder 42B, which will be described later, is disposed in the opening 34H.

Each of the two ribs 69 protrudes upward from the first guide surface 61 and extends in the feeding direction DF1, with the opening 34H and the separation holder 42B located between the two ribs 69 in the widthwise direction. When viewed along the widthwise direction, each rib 69 has a substantially triangular shape in which a length of a base is significantly greater than a height from the base to an apex.

Each of the second guide surfaces 62 is an upper end surface of a corresponding one of the two ribs 69. The two second guide surfaces 62 are arranged alongside the first guide surface 61 in the widthwise direction. The opening 34H and the separation holder 42B are positioned between the two second guide surfaces 62 in the widthwise direction. Each second guide surface 62 has a first inclined surface 62A and a second inclined surface 62B.

An upstream end in the feeding direction DF1 of the first inclined surface 62A is connected to the downstream end 95D of the support surface 95. The first inclined surface 62A is inclined so as to rise toward a downstream side in the feeding direction DF1. In other words, the first inclined surface 62A is inclined such that a distance, in the up-down direction, between the first inclined surface 62A and the first guide surface 61 increases toward the downstream side in the feeding direction DF1.

The second inclined surface 62B is connected to the first inclined surface 62A at a connection portion 62C. The second inclined surface 62B is inclined so as to descend toward a downstream side in the feeding direction DF1. In other words, the second inclined surface 62B is inclined such that the distance, in the up-down direction, between the second inclined surface 62B and the first guide surface 61 decreases toward the downstream side in the feeding direction DF1.

As shown in FIG. 2, the cover 9 includes the conveying unit 4, a first conveying guide 31, a second conveying guide 32, and a third conveying guide 33. The conveying unit 4 and the first to third conveying guides 31, 32, and 33 are located inside a left-side portion of the cover 9.

The conveying unit 4 includes a feeding roller 41, a separation roller 42, a separation holder 42B, a separation pad 42A, a holder 50, a first conveying roller pair 43, a pressing member 44, a second conveying roller pair 45, a discharge roller 47, and an elastic piece 48.

The feeding roller 41 is located upstream of the downstream end 95D of the support surface 95 in the feeding direction DF1. The feeding roller 41 faces a central portion in the widthwise direction of the first support surface 91S from above.

The separation roller 42 is located downstream of both the feeding roller 41 and the downstream end 95D of the support surface 95 in the feeding direction DF1. The separation roller 42 faces the conveyance guide surface 34G from above. The separation roller 42 is mounted on a drive shaft 42S having a drive axis X42 extending in the widthwise direction.

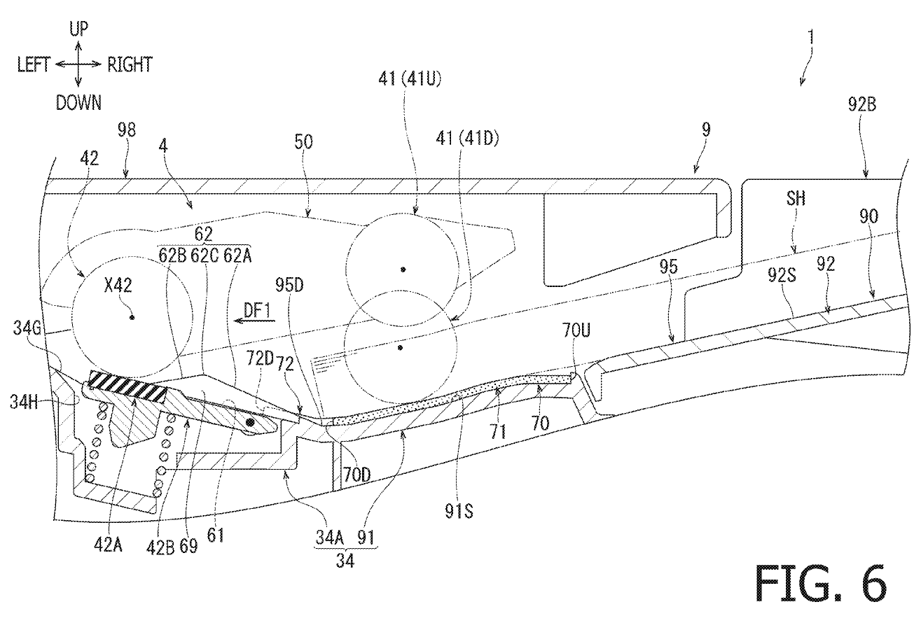

As shown in FIG. 6, in each second guide surface 62, the connection portion 62C between the first inclined surface 62A and the second inclined surface 62B is located upstream of the separation roller 42 in the feeding direction DF1.

As shown in FIG. 2, the separation holder 42B is located in the opening 34H of the conveyance guide surface 34G and faces the separation roller 42 from below. The separation holder 42B is swingably supported by the guide portion 34A so as to be movable toward and away from the separation roller 42.

The separation pad 42A is located on the separation holder 42B. A biasing spring urges the separation holder 42B upward, thereby pressing the separation pad 42A toward the separation roller 42.

As shown in FIG. 2, the holder 50 has the drive shaft 42S inserted therethrough. The holder 50 extends to the right of the drive axis X42 and supports the feeding roller 41 rotatably at a right-end side thereof.

Between the holder 50 and the drive shaft 42S, a conventional torque limiter is interposed. The holder 50 supports a conventional gear train that transmits a driving force from the drive shaft 42S to the feeding roller 41.

A driving force from a well-known drive source, such as a motor, is transmitted to the drive shaft 42S, so that the drive shaft 42S rotates about the drive axis X42.

When the drive source rotates in a forward direction, the torque limiter causes the holder 50 to follow the rotation of the drive shaft 42S. As a result, the holder 50 swings so as to lower the feeding roller 41. When the feeding roller 41 comes into contact with an uppermost sheet SH supported on the support surface 95, the torque limiter begins to slip internally, thereby holding the holder 50 at that position. Consequently, the feeding roller 41 presses the sheet SH supported on the support surface 95 downward.

In this state, the drive shaft 42S transmits a driving force to the separation roller 42 to rotate the separation roller 42 about the drive axis X42 and also transmits a driving force to the feeding roller 41 via the above-mentioned gear train to rotate the feeding roller 41. The feeding roller 41 then feeds an uppermost sheet SH supported on the support surface 95 in the feeding direction DF1. The first guide surface 61 of the conveyance guide surface 34G guides the sheet SH fed by the feeding roller 41. The second guide surfaces 62 of the conveyance guide surface 34G guide the sheet SH such that a central portion of the sheet SH in the widthwise direction is lifted upward away from the first guide surface 61. The separation roller 42 conveys the sheet SH, which has been fed by the feeding roller 41 and guided by the first guide surface 61 and the second guide surfaces 62, in the feeding direction DF1. During this conveyance, the separation roller 42 and the separation pad 42A separate the sheets SH one by one if multiple sheets SH are fed by the feeding roller 41.

When the drive source rotates in a reverse direction, the torque limiter causes the holder 50 to follow the reverse rotation of the drive shaft 42S. As a result, the holder 50 swings so as to raise the feeding roller 41.

A position of the feeding roller 41 (41U) shown in each of FIGS. 2, 6, and 7 is an upper limit position. When the feeding roller 41 reaches the upper limit position, the torque limiter begins to slip internally, thereby holding the holder 50 at that position.

At this stage, rotation of the separation roller 42 and the feeding roller 41 is unnecessary. Therefore, when the feeding roller 41 reaches the upper limit position, a controller (not shown) immediately stops the drive source. It should be noted that the torque limiter continues to hold the holder 50 at that position after the drive source has been stopped.

The feeding roller 41 is configured such that it is capable of contacting the first portion 71 of the friction member 70 when no sheet SH is supported on the support surface 95. FIGS. 2, 6, and 7 show a lower limit position of the feeding roller 41 (41D), where the feeding roller 41 comes into contact with the first portion 71 of the friction member 70.

As shown in FIG. 2, a first conveying roller pair 43 is located toward a left-side wall of the cover 9 at a position close to an upper surface of the main body 8. A pressing member 44 is located immediately above the reading surface 3B.

The first conveying guide 31 includes the conveyance guide surface 34G and ribs or the like that project downward from a back surface of the left-side upper cover 98. The first conveying guide 31 is configured to guide sheets SH supported on the support surface 95 to the first conveying roller pair 43.

The second conveying guide 32 includes a portion of a chute member that is located at a lower level than the guide portion 34A of the upper chute 34 inside the cover 9, and a guide surface or the like formed on an inner side close to a left-side wall of the cover 9.

The second conveying guide 32 guides a sheet SH from the first conveying roller pair 43 toward the reading surface 3B along a downward slope, and then guides the sheet SH so as to pass between the pressing member 44 and the reading surface 3B, that is, above the reading sensor 3S located at the stationary reading position.

The second conveying roller pair 45 is located at a position that is spaced upward and leftward from a left end of the discharge tray 96. The discharge roller 47 is located at a position spaced upward from the left end of the discharge tray 96 and slightly offset leftward from the same left end. An upper end of the discharge roller 47 is positioned higher than a nip position of the second conveying roller pair 45.

The elastic piece 48 is made of a high-rigidity film. The elastic piece 48 is cantilevered between the second conveying roller pair 45 and the discharge roller 47 so as to protrude rightward and is bent at a position to the right of the discharge roller 47 so as to extend downward toward the right.

In the present embodiment, the conveying unit 4 includes a plurality of discharge rollers 47 and a plurality of elastic pieces 48 arranged alternately in the widthwise direction. For ease of illustration, FIG. 2 shows one discharge roller 47 and one elastic piece 48, while the actual conveying unit 4 is provided with the plurality of discharge rollers 47 and the plurality of elastic pieces 48 in the widthwise direction.

The third conveying guide 33 includes a lower surface of the chute member that is located, inside the cover 9, at a lower level than the first tray 91 and the second tray 92, and an upwardly facing conveyance guide surface formed between the reading surface 3B and the discharge tray 96 in the base member 39.

The third conveying guide 33 guides a sheet SH, at a position to the right of the reading surface 3B, upward toward the right so that the sheet SH passes through the second conveying roller pair 45, and further guides the sheet SH to the discharge roller 47 and the elastic piece 48.

As shown in FIGS. 4 to 7, the image reading apparatus 1 includes the friction member 70. The friction member 70 has the first portion 71 and two second portions 72. The first portion 71 and each of the second portions 72 are continuous with one another in the feeding direction DF1.

The friction member 70 is made of a material that is configured to apply to the sheets SH a frictional force higher than that applied by a resin material forming the first tray 91. An example of the friction member 70 is cork, rubber, or an elastomer. In the present embodiment, the friction member 70 is formed such that the first portion 71 and each of the second portions 72 are cut out integrally from a cork sheet having a thickness of about 1mm.

As shown in FIG. 4, the first portion 71 is provided on the support surface 95. More specifically, the first portion 71 is affixed to the first support surface 91S at a central region thereof in the widthwise direction by double-sided tape or the like.

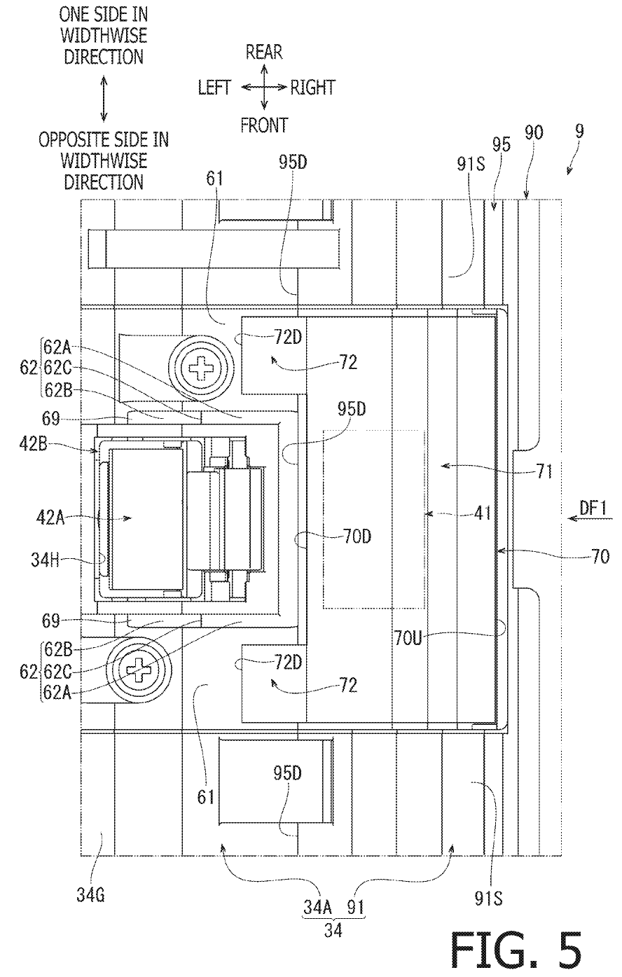

As shown in FIG. 5, the first portion 71 has a rectangular shape in which a length in the widthwise direction is greater than a length in the feeding direction DF1. In the present embodiment, by way of example, the length of the first portion 71 in the widthwise direction is approximately 6 mm. The length of the feeding roller 41 in the widthwise direction is approximately 27mm in this embodiment. In the present embodiment, by way of example, the length of the first portion 71 in the widthwise direction is between twice and three times the length of the feeding roller 41 in the widthwise direction.

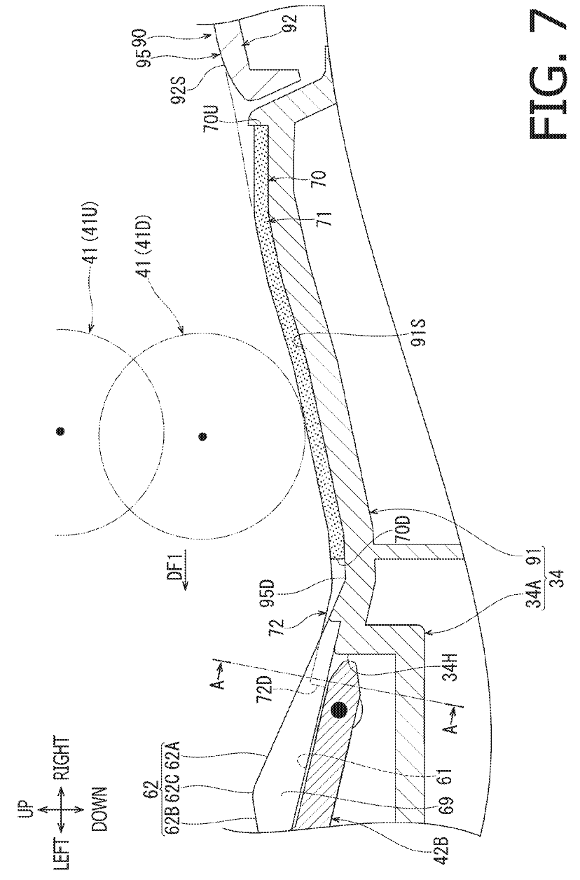

As shown in FIGS. 5 and 7, an upstream end 71U of the first portion 71 in the feeding direction DF1 is located in the vicinity of an upstream end of the first support surface 91S in the feeding direction DF1. A downstream end 71D of the first portion 71 in the feeding direction DF1 is slightly offset upstream from a downstream end 95D of the support surface 95.

As shown in FIG. 6, the first portion 71 faces the feeding roller 41 from below. The first portion 71 contacts a lowermost sheet SH supported on the support surface 95 and applies a frictional force thereto. As shown in FIG. 7, the friction member 70 is configured such that, when no sheet SH is supported on the support surface 95, the first portion 71 contacts the feeding roller 41 (41D) that has descended to the lower limit position.

As shown in FIG. 5, each of the second portions 72 has a rectangular shape that is significantly smaller than that of the first portion 71. A second portion 72 located on one side in the widthwise direction is connected to a region on that one side in the widthwise direction at a downstream end 71D of the first portion 71. A second portion 72 located on the other side in the widthwise direction is connected to a region on the other side in the widthwise direction at the downstream end 71D of the first portion 71. When viewed in an up-down direction, the first portion 71 and the second portions 72 together form a generally U-shaped configuration.

Each of the second portions 72 is provided on the first guide surface 61. More specifically, a second portion 72 located on one side in the widthwise direction is positioned on the one-side second guide surface 62 at a location opposite to the opening 34H and the separation holder 42B in the widthwise direction, and is affixed to the first guide surface 61 by double-sided tape or the like. Likewise, a second portion 72 located on the other side in the widthwise direction is positioned on the other-side second guide surface 62 at a location opposite to the opening 34H and the separation holder 42B in the widthwise direction and is affixed to the first guide surface 61 by double-sided tape or the like.

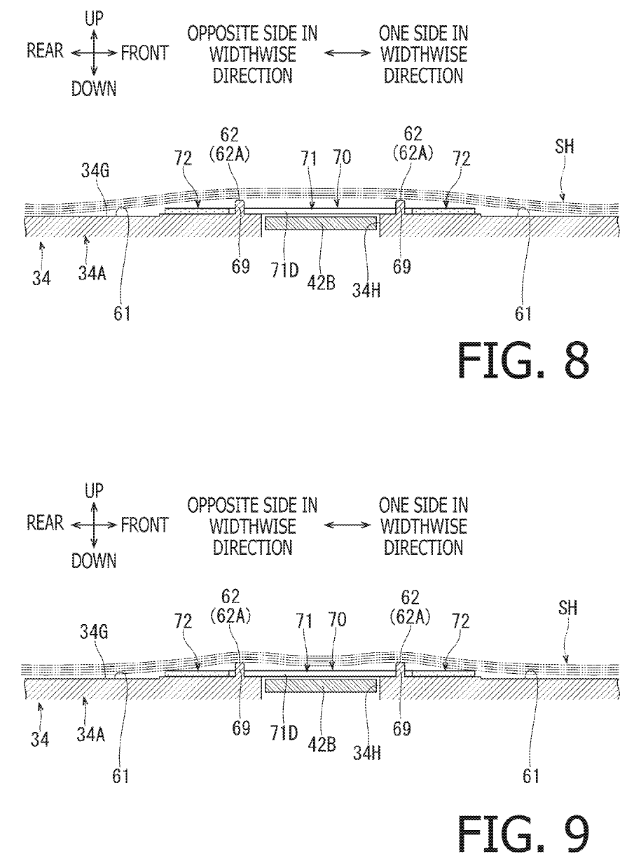

In other words, as shown in FIG. 8, each of the second portions 72 is arranged alongside a corresponding second guide surface 62 in the widthwise direction. The two second guide surfaces 62 are positioned between the two second portions 72 in the widthwise direction. The opening 34H and the separation holder 42B are also positioned between the two second portions 72 in the widthwise direction.

As shown in FIG. 4, each of the second portions 72 is inclined along the first guide surface 61 such that its height increases toward a downstream side in the feeding direction DF1.

As shown in FIGS. 4 and 7, each of the second portions 72 is configured such that a region thereof, including the downstream end 72D in the feeding direction DF1, is positioned below the second guide surface 62.

As shown in FIGS. 8 and 9, each of the second portions 72 is configured to apply a frictional force to the sheet SH that is guided by the first guide surface 61 and the second guide surfaces 62.

More specifically, as shown in FIG. 8, when a non-deformed sheet SH is guided by the first guide surface 61 and the second guide surfaces 62, a portion of the sheet SH facing each of the second portions 72 tends not to sag downward. Therefore, the non-deformed sheet SH tends to be spaced upward from the second portions 72, and in particular from a region of each second portion 72 including a downstream end 72D in the feeding direction DF1. As a result, application of a frictional force by the second portions 72 to the non-deformed sheet SH is suppressed.

As shown in FIG. 9, a deformed sheet SH, particularly a sheet SH that is deformed so as to undulate along the widthwise direction, tends to have a portion thereof facing each of the second portions 72 sag downward when guided by the first guide surface 61 and the second guide surfaces 62. Therefore, the deformed sheet SH readily comes into contact with the second portions 72, and in particular with a region of each second portion 72 including a downstream end 72D in the feeding direction DF1. As a result, each second portion 72 more easily applies a frictional force to the deformed sheet SH.

When the image reading unit 3 reads an image of a sheet SH supported on the support surface 95 in the image reading apparatus 1, the controller controls the drive source to rotate in the forward direction, thereby causing the conveying unit 4 to operate.

The conveying unit 4 rotationally drives the feeding roller 41 and the separation roller 42 clockwise as viewed in FIG. 2, drives the driven roller 43A of the first conveying roller pair 43 and the driven roller 45A of the second conveying roller pair 45 counterclockwise as viewed in FIG. 2, and drives the discharge roller 47 clockwise as viewed in FIG. 2. As a result, the holder 50 swings so as to lower the feeding roller 41 (41U) from the upper limit position until the feeding roller 41 comes into contact with the uppermost sheet SH supported on the support surface 95. When the feeding roller 41 contacts the uppermost sheet SH, the feeding roller 41 presses the sheet SH downward. In this state, the feeding roller 41 feeds the uppermost sheet SH in the feeding direction DF1. At this time, the first portion 71 of the friction member 70 contacts the lowermost sheet SH supported on the support surface 95 and applies a frictional force thereto. When a sheet SH guided by the first guide surface 61 and the second guide surfaces 62 is deformed to be wavy along the widthwise direction, the second portions 72 of the friction member 70 tend to come into contact with portions of the sheet SH facing the corresponding second portions 72, respectively, and thereby tend to apply a frictional force to the sheet SH. As a result, the image reading apparatus 1 can suppress double feeding of the sheets SH.

If multiple sheets SH are fed by the feeding roller 41, the separation roller 42 and the separation pad 42A function to separate the sheets SH into single sheets and convey only one sheet SH at a time toward the first conveying roller pair 43.

Next, the first conveying roller pair 43 conveys the sheet SH, which is guided by the first conveying guide 31 and the second conveying guide 32, so as to pass above the reading sensor 3S located at the stationary reading position. This allows the reading sensor 3S to read an image of the sheet SH.

The second conveying roller pair 45 then conveys the sheet SH, which is guided by the third conveying guide 33, toward the discharge roller 47 and the elastic piece 48. The discharge roller 47 and the elastic piece 48 discharge the sheet SH onto the discharge tray 96 while deforming the sheet SH into a wave shape.

At this time, the discharge roller 47 and the elastic piece 48 discharge the sheet SH onto the discharge tray 96 from a position higher than a nip position of the second conveying roller pair 45.

When the image-reading operation for the sheet SH is completed, the controller drives the drive source in the reverse direction for a short period of time. As a result, the holder 50 swings so as to raise the feeding roller 41 to the upper limit position. Consequently, the feeding roller 41 (41U), having moved to the upper limit position, returns to a state in which the feeding roller 41 (41U) is spaced upward away from the uppermost sheet SH supported on the support surface 95.

In a sheet feeding device without the countermeasure described below, curled sheets SH, for example sheets SH that have become curled due to a curl set or moisture absorption, may be supported in a stacked state on the support surface 95 of the supply tray 90. In such a case, when the feeding roller 41 attempts to feed the curled sheets SH one by one, a pressing force applied by the feeding roller 41 to the sheets SH tends to fluctuate. As a result, a frictional force applied by the first portion 71 of the friction member 70 to the sheets SH supported on the support surface 95 also tends to fluctuate. If no countermeasure is taken, the sheets SH remaining on the support surface 95 may bounce and advance in the feeding direction DF1.

According to the present embodiment, however, the image reading apparatus 1 includes the first guide surface 61 and the second guide surfaces 62 as shown in FIGS. 4 and 5. In addition, the friction member 70 includes not only the first portion 71 but also two second portions 72.

In this manner, as shown in FIG. 9, when deformed sheets SH, in particular sheets SH that are deformed to be wavy along the widthwise direction, are supported in a stacked state on the support surface 95, and in the case where the sheets SH remaining on the support surface 95 tend to bounce and proceed toward the first guide surface 61 and the second guide surfaces 62, the deformed sheets SH may easily come into contact with the second portions 72. In particular, the deformed sheets SH may easily come into contact with parts of the second portions 72 that include the downstream ends 72D in the feeding direction DF1. As a result, the second portions 72 apply a frictional force to the deformed sheets SH and thereby suppress the sheets SH from advancing in the feeding direction DF1.

As shown in FIG. 8, when non-deformed sheets SH are supported in a stacked state on the support surface 95, and in the case where the sheets SH are fed one by one by the feeding roller 41, a pressing force applied by the feeding roller 41 to the sheets SH does not fluctuate significantly. As a result, a frictional force applied by the first portion 71 of the friction member 70 to the sheets SH supported on the support surface 95 also does not fluctuate significantly. Therefore, the sheets SH remaining on the support surface 95 are unlikely to bounce and are unlikely to proceed in the feeding direction DF1. When a non-deformed sheet SH is guided by the first guide surface 61 and the second guide surfaces 62, the sheet SH tends to lift away from the second portions 72. In particular, the sheet SH tends to lift away from parts of the second portions 72 that include the downstream ends 72D in the feeding direction DF1. Consequently, application of a frictional force by the second portions 72 to the non-deformed sheet SH is suppressed. As a result, the non-deformed sheet SH is prevented from being unnecessarily stopped by the second portions 72.

Therefore, the image reading apparatus 1 according to the present embodiment can suppress double feeding of sheets SH even when deformed sheets SH are supported in a stacked state on the support surface 95. In addition, when non-deformed sheets SH are supported in a stacked state on the support surface 95, the conveyance of the sheets SH is not unnecessarily suppressed.

In the image reading apparatus 1, as shown in FIG. 4, the second guide surfaces 62 are provided such that, in the widthwise direction, the opening 34H and the separation holder 42B are positioned between the two second guide surfaces 62. The second portions 72 are also provided such that, in the widthwise direction, the opening 34H and the separation holder 42B are positioned between the two second portions 72. With this configuration, as shown in FIG. 9, when a deformed sheet SH is guided by the first guide surface 61 and the second guide surfaces 62, each second portion 72 is located below a portion of the deformed sheet SH that tends to sag. As a result, even if sheets SH remaining on the support surface 95 bounce and move toward the first guide surface 61 and the second guide surfaces 62, each second portion 72 applies a frictional force to the deformed sheet SH with high certainty, thereby suppressing advancement of the deformed sheet SH in the feeding direction DF1 with high certainty. In addition, this configuration suppresses skewing of sheets SH guided by the first guide surface 61 and the second guide surfaces 62.

Furthermore, in the image reading apparatus 1, as shown in FIG. 4, the second portions 72 are provided such that the second guide surfaces 62 are positioned between the second portions 72 in the widthwise direction. With this configuration, as shown in FIG. 9, when a deformed sheet SH is guided by the first guide surface 61 and the second guide surfaces 62, the second portions 72 are located with high certainty below a portion of the sheet SH that tends to sag. As a result, even if the sheets SH remaining on the support surface 95 bounce and proceed toward the first guide surface 61 and the second guide surfaces 62, each second portion 72 applies a frictional force to the deformed sheet SH with even higher certainty and thereby suppresses the sheet SH from advancing in the feeding direction DF1 with even higher certainty.

In the image reading apparatus 1, as shown in FIG. 4, the first portion 71 and each of the second portions 72 are formed to be continuous in the feeding direction DF1. With this configuration, it becomes unlikely that a leading end of a sheet SH fed by the feeding roller 41 will catch between the first portion 71 and the second portions 72, thereby reducing the likelihood of a feeding failure.

Still further, in the image reading apparatus 1, each second guide surface 62 is formed as an upper end surface of a corresponding rib 69 that projects upward from the first guide surface 61 and extends in the feeding direction DF1. With this configuration, each second guide surface 62 is capable of lifting a central portion of a sheet SH in the widthwise direction away from the first guide surface 61 with high certainty when the sheet SH is fed by the feeding roller 41.

In the image reading apparatus 1, each second guide surface 62 includes a first inclined surface 62A and a second inclined surface 62B. As shown in FIG. 6, a connection portion 62C between the first inclined surface 62A and the second inclined surface 62B is located upstream of the separation roller 42 in the feeding direction DF1. With this configuration, each second guide surface 62 is capable of lifting a central portion of a sheet SH in the widthwise direction away from the first guide surface 61 with high certainty by means of the first inclined surface 62A when the sheet SH is fed by the feeding roller 41, and then guiding the sheet SH smoothly to a nip position between the separation roller 42 and the separation pad 42A by means of the second inclined surface 62B.

Still further, in the image reading apparatus 1, as shown in FIG. 4, the first guide surface 61 is inclined so as to rise toward a downstream side in the feeding direction DF1. With this configuration, when a leading edge of a sheet SH fed by the feeding roller 41 rides upward along the first guide surface 61, and when the sheet SH is a deformed sheet SH, the sheet SH easily comes into contact with the second portions 72 provided on the first guide surface 61. Therefore, when deformed sheets SH are supported in a stacked state on the support surface 95, and when the sheets SH remaining on the support surface 95 bounce toward the first guide surface 61 and the second guide surfaces 62, each second portion 72 applies a frictional force to the deformed sheet SH with high certainty and thereby suppresses the sheet SH from advancing in the feeding direction DF1 with high certainty.

While aspects of the present disclosure have been described in conjunction with various example structures outlined above and illustrated in the figures, various alternatives, modifications, variations, improvements, and/or substantial equivalents, whether known or that may become apparent to those having at least ordinary skill in the art, may be adopted. Accordingly, the example embodiments described above are intended to be illustrative of aspects of the present disclosure and are not intended to limit the present disclosure. Various changes may be made without departing from the spirit and scope of the present disclosure. Therefore, the present disclosure is intended to embrace all known or later developed alternatives, modifications, variations, improvements, and/or substantial equivalents. Some specific examples of potential alternatives, modifications, or variations applicable to the described aspects are provided below.

In the embodiment described above, the sheet feeding device according to the present disclosure is implemented as the image reading apparatus 1 having both an image forming function and an image reading function. However, the present disclosure is not limited to this configuration. For example, the configuration of the present disclosure may be applied to an image reading apparatus having only an image reading function, or may be applied to an image forming apparatus having only an image forming function.

In the embodiment described above, the first portion 71 and each of the second portions 72 are formed to be continuous in the feeding direction DF1. However, the present disclosure is not limited to this configuration. For example, a configuration is also encompassed by the present disclosure in which the first portion 71 and each second portion 72 are formed as separate bodies, and an upstream end in the feeding direction DF1 of each second portion 72 is located below a downstream end 71D of the first portion 71 so as to form a downward step in the feeding direction DF1. This configuration also makes it unlikely that a leading edge of a sheet SH fed by the feeding roller 41 will catch between the first portion 71 and the second portions 72.

In the embodiment described above, the second portions 72 are provided such that the second guide surfaces 62 are positioned between the second portions 72 in the widthwise direction. However, the present disclosure is not limited to this configuration. For example, a configuration is also encompassed by the present disclosure in which the second guide surfaces 62 are provided such that the second portions 72 are positioned between the second guide surfaces 62 in the widthwise direction.

What is claimed is:

1. A sheet feeding device comprising:
a supply tray having a support surface configured to support sheets in a stacked state;
a feeding roller configured to feed a sheet supported on the support surface in a feeding direction that is orthogonal to a widthwise direction of the sheets supported on the support surface;
a first guide surface located downstream of the support surface in the feeding direction and configured to guide a sheet fed by the feeding roller;
a second guide surface located downstream of the support surface in the feeding direction and arranged alongside the first guide surface in the widthwise direction, the second guide surface being configured to guide a portion of the sheet in the widthwise direction so as to lift the portion away from the first guide surface; and
a friction member,
wherein the friction member includes:
a first portion provided on the support surface, the first portion facing the feeding roller from below and being configured to apply a frictional force to a sheet supported on the support surface; and
a second portion provided on the first guide surface, the second portion being arranged alongside the second guide surface in the widthwise direction and having at least a part thereof including a downstream end in the feeding direction located below the second guide surface, the second portion being capable of applying a frictional force to a sheet guided by the first guide surface and the second guide surface.

2. The sheet feeding device according to claim 1, further comprising:
a separation roller located downstream of the feeding roller in the feeding direction and configured to convey, in the feeding direction, a sheet guided by the first guide surface and the second guide surface;
a separation holder disposed to face the separation roller from below and configured to be movable toward and away from the separation roller; and
a separation pad located on the separation holder and urged toward the separation roller,
wherein two of the second guide surfaces are provided such that the separation holder is positioned between the two of the second guide surfaces in the widthwise direction, and
wherein two of the second portions are provided such that the separation holder is positioned between the two of the second guide surfaces in the widthwise direction.

3. The sheet feeding device according to claim 2, wherein the two of the second portions are provided such that the two of the second guide surfaces are positioned between the two of the second portions in the widthwise direction.

4. The sheet feeding device according to claim 1, wherein the first portion and the second portion are continuous in the feeding direction.

5. The sheet feeding device according to claim 2, wherein the first portion and each of the two second portions are continuous in the feeding direction.

6. The sheet feeding device according to claim 2, wherein each second guide surface is an upper end surface of a rib that projects upward from the first guide surface and extends in the feeding direction.

7. The sheet feeding device according to claim 3, wherein each second guide surface is an upper end surface of a rib that projects upward from the first guide surface and extends in the feeding direction.

8. The sheet feeding device according to claim 6, wherein each of the two of the second guide surfaces includes a first inclined surface that is inclined so as to rise toward a downstream side in the feeding direction and a second inclined surface that is connected to the first inclined surface and inclined so as to descend toward the downstream side in the feeding direction, and wherein a connecting portion between the first inclined surface and the second inclined surface is located upstream of the separation roller in the feeding direction.

9. The sheet feeding device according to claim 7, wherein each of the two of the second guide surfaces includes a first inclined surface that is inclined so as to rise toward a downstream side in the feeding direction and a second inclined surface that is connected to the first inclined surface and inclined so as to descend toward the downstream side in the feeding direction, and wherein a connecting portion between the first inclined surface and the second inclined surface is located upstream of the separation roller in the feeding direction.

10. The sheet feeding device according to claim 1, wherein the first guide surface is inclined so as to rise toward a downstream side in the feeding direction.

11. The sheet feeding device according to claim 2 , wherein the first guide surface is inclined so as to rise toward a downstream side in the feeding direction.

12. The sheet feeding device according to claim 3, wherein the first guide surface is inclined so as to rise toward a downstream side in the feeding direction.

13. A sheet feeding device comprising:
a supply tray having a support surface configured to support sheets in a stacked state; a feeding roller configured to feed a sheet supported on the support surface in a feeding direction that is orthogonal to a widthwise direction of the sheets supported on the support surface;
a first guide surface located downstream of the support surface in the feeding direction and configured to guide a sheet fed by the feeding roller;
two second guide surfaces each located downstream of the support surface in the feeding direction and arranged alongside the first guide surface in the widthwise direction, each second guide surface being configured to guide a portion of the sheet in the widthwise direction so as to lift the portion away from the first guide surface; and
a friction member,
wherein the friction member includes:
a first portion provided on the support surface, the first portion facing the feeding roller from below and being configured to apply a frictional force to a sheet supported on the support surface; and
two second portions provided on the first guide surface, each second portion being arranged alongside a corresponding one of the two second guide surfaces in the widthwise direction, each second portion having at least a part thereof including a downstream end in the feeding direction located below the corresponding second guide surface, and each second portion being capable of applying a frictional force to a sheet guided by the first guide surface and the corresponding second guide surface.
